(19) United States
(12) Patent Application Publication
(10) Pub. No.: US 2025/0086744 A1
(43) Pub. Date: Mar. 13, 2025

(54) SYSTEM FOR CONTROLLING FERRY, METHOD OF CONTROLLING FERRY, AND FERRY

(71) Applicant: YAMAHA HATSUDOKI KABUSHIKI KAISHA, Iwata-shi (JP)

(72) Inventor: Hiroshi INOUE, Shizuoka (JP)

(21) Appl. No.: 18/882,879

(22) Filed: Sep. 12, 2024

(30) Foreign Application Priority Data
Sep. 13, 2023 (JP) 2023-148322

(51) Int. Cl. G06Q 50/40; G01C 21/20; H04W 4/021; H04W 4/029

(52) U.S. Cl. CPC G06Q 50/40; G01C 21/203; H04W 4/021; H04W 4/029

(57) ABSTRACT

A ferry controlling system for controlling a ferry in a marina where a watercraft of a user is moored and stored includes a controller and a storage. The storage stores identification information identifying the user, first location information regarding a first location where a ferry is docked/undocked, and second location information regarding a second location on the water where the watercraft of the user is moored and stored. Upon receiving the identification information, the controller is configured or programmed to allow driving of the ferry and set the second location as a destination of the ferry based on the second location information.

### CROSS REFERENCE TO RELATED APPLICATIONS

This application claims the benefit of priority to Japanese Patent Application No. 2023-148322 filed on Sep. 13, 2023. The entire contents of this application are hereby incorporated herein by reference.

### BACKGROUND OF THE INVENTION

### 1. Field of the Invention

The present invention relates to systems for controlling ferries, methods of controlling ferries, and ferries.

### 2. Description of the Related Art

There has been conventionally disclosed a watercraft mooring management server for managing the use of a mooring at which watercraft are moored (see Japan Laid-open Patent Application Publication No. 2019-049880).

In a marina where one or more watercraft are moored and stored on water, a user is required to reach one's own watercraft moored and stored on the water by a ferry operated by the marina. When the marina is closed, for example, on a holiday, the user is required to obtain a ferry for oneself.

### SUMMARY OF THE INVENTION

Example embodiments of the present invention enhance the usability of ferries in a marina where one or more watercraft are moored and stored.

A system for controlling a ferry in a marina where a watercraft of a user is moored and stored includes a controller and a storage. The storage is operable to store identification information identifying the user, first location information regarding a first location where the ferry is docked/undocked, and second location information regarding a second location on the water where the watercraft of the user is moored and stored. The controller is configured or programmed to allow driving of the ferry upon receiving the identification information, and set the second location as a destination of the ferry based on the second location information.

In the system for controlling a ferry, the controller is configured or programmed to allow driving of the ferry based on the identification information identifying the user of the watercraft. Thus, even when the marina is closed on, for example, holiday, the user is able to arrive at the user's moored and stored watercraft by using the ferry in the marina. Additionally, the ferry is prevented from being used by anyone other than the users of the marina without permission. Furthermore, the controller is configured or programmed to set the location, corresponding to the location where the watercraft of the user is moored and stored, as the destination of the ferry. Thus, the user is able to easily arrive at the user's moored and stored watercraft.

A system for controlling a ferry transporting a user to a watercraft that is moored and stored includes a controller and a storage. The storage is operable to store identification information identifying the user, first location information regarding a first location where the ferry is docked/undocked, and second location information regarding a second location on the water where the watercraft of the user is moored and stored. The controller is configured or programmed to allow driving of the ferry upon receiving the identification information, and set the second location as a destination of the ferry based on the second location information.

A method of controlling a ferry in a marina where a watercraft of a user is moored and stored includes storing identification information identifying the user, first location information regarding a first location where the ferry is docked/undocked, and second location information regarding a second location on the water where the watercraft of the user is moored and stored; and allowing driving of the ferry and setting the second location as a destination of the ferry based on the second location information when the identification information is received.

A ferry in a marina where a watercraft of a user is moored and stored includes a controller and a storage. The storage is operable to store identification information identifying the user, first location information regarding a first location where the ferry is docked/undocked, and second location information regarding a second location on the water where the watercraft of the user is moored and stored. The controller is configured or programmed to allow driving of the ferry upon receiving the identification information, and set the second location as a destination of the ferry based on the second location information.

According to example embodiments the present invention, it is possible to enhance the usability of a ferry in a marina where one or more watercraft are moored and stored.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic diagram showing a ferry controlling system according to an example embodiment of the present invention.

FIG. 2 is a schematic diagram of a marina according to an example embodiment of the present invention. system.

FIG. 4 is a flowchart showing processes executed by a controller.

FIG. 5 is a flowchart showing processes executed by the controller.

FIG. 6 is a schematic diagram of a marina including piers. FIG. 3 is a functional block diagram of the ferry controlling

### DETAILED DESCRIPTION OF THE EXAMPLE EMBODIMENTS

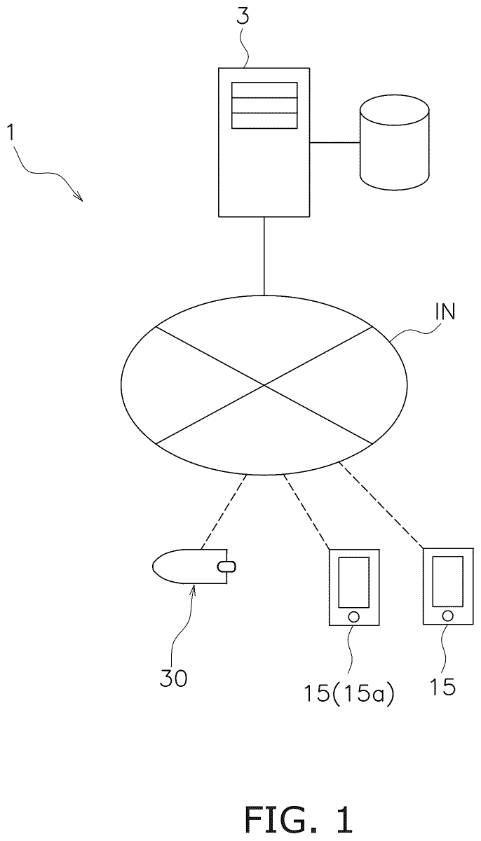

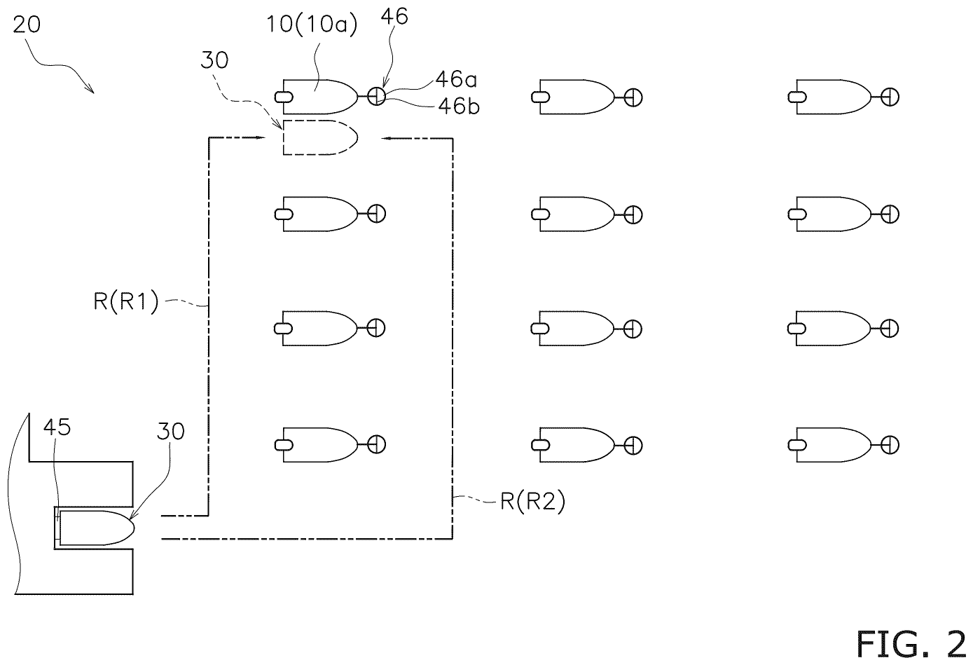

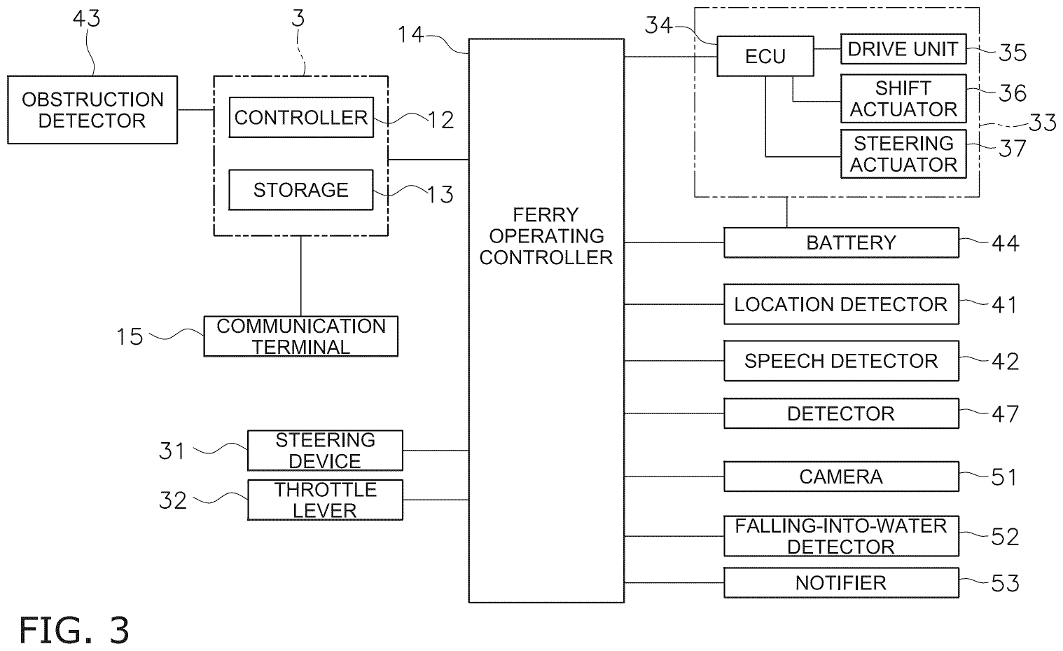

Example embodiments of the present invention will be hereinafter explained with reference to the drawings. As shown in FIGS. 1 and 2, a ferry controlling system 1 controls a ferry in a marina 20 where a plurality of watercraft 10 are moored and stored. The marina 20 is a place where the plurality of watercraft 10 are moored and stored on the water. For example, the plurality watercraft 10 moored and stored on the water refers to the plurality of watercraft 10 in locations on the water at which users cannot arrive on foot from land. In other words, the land where the marina 20 is located and the plurality of watercraft 10 moored and stored on the water are not physically contiguous. The ferry controlling system 1 uses a ferry 30 to transport a user from the land where the marina 20 is located to the moored and stored user's watercraft 10 and from the moored and stored user's watercraft 10 to the land where the marina 20 is located by the ferry 30.

As shown in FIG. 2, the plurality of watercraft 10 are moored and stored away from each other at spaced apart intervals in the marina 20. In FIG. 2, only one of the plurality of watercraft 10 is assigned reference character 10. In FIG. 2, the watercraft 10 of a first user is assigned reference character 10a.

FIG. 3 is a functional block diagram of the ferry controlling system 1. The ferry 30 includes a steering device 31, a throttle lever 32, and a marine propulsion device 33. The steering device 31 is operable to turn the direction of the ferry 30. The throttle lever 32 is operable to regulate a thrust of the marine propulsion device 33 and switch a direction of the thrust between fore and aft directions.

The marine propulsion device 33 includes an ECU (Electric Control Unit) 34, a drive unit 35, a shift actuator 36, and a steering actuator 37.

The ECU 34 includes a processor such as a CPU (Central Processing Unit) and memories such as a RAM (Random Access Memory) and a ROM (Read Only Memory). The ECU 34 stores programs and data to control the marine propulsion device 33. The ECU 34 controls the drive unit 35. The drive unit 35 generates the thrust to propel the ferry 30. The drive unit 35 includes an electric motor 35a to rotate a propeller (not shown in the drawings). The drive unit 35 may be an internal combustion engine.

The shift actuator 36 changes a rotational direction of the propeller rotated by the electric motor 35a in accordance with an operation performed on the throttle lever 32. The steering actuator 37 changes a rudder angle of the marine propulsion device 33 in accordance with an operation performed on the steering device 31.

The ferry controlling system 1 includes a server 3. The server 3 is used as, for instance, a computer to manage the ferry 30. The server 3 is hosted by, for instance, a company that manages and operates the marina 20. The server 3 is configured or programmed to be communicable, in a wireless manner, with one or more communication terminals 15 used by one or more of the users of the plurality of watercraft 10. In the present example embodiment, the server 3 is communicable with the one or more communication terminals 15 over the Internet IN. The server 3 is communicable with the one or more communication terminals 15 through, for instance, an application, software, or hardware used by the ferry controlling system. The one or more communication terminals 15 may be, for example, any one or more of a smartphone, a tablet, etc. In the present example embodiment, the one or more communication terminals 15 are a plurality of communication terminals 15. In FIG. 1, the communication terminal 15 used by the first user is assigned reference character 15a.

The server 3 includes a controller 12 and a storage 13. The controller 12 includes a processor such as a CPU and memories such as a RAM and a ROM.

The controller 12 controls a ferry operating controller 14 on the ferry 30. The controller 12 controls the ferry 30 through the ferry operating controller 14. The ferry operating controller 14 is configured or programmed to be communicable with the controller 12. The ferry operating controller 14 includes a processor such as a CPU and memories such as a RAM and a ROM. The ferry operating controller 14 is configured or programmed to control the ferry 30. The ferry operating controller 14 includes programs and data stored therein to control the marine propulsion device 33. The ferry operating controller 14 is connected to the steering device 31, the throttle lever 32, and the marine propulsion device 33 through wired or wireless communications. The ferry operating controller 14 controls the shift actuator 36 and the steering actuator 37 through the ECU 34. The ferry operating controller 14 controls a rotational speed of the electric motor 35a in accordance with an operating amount of the throttle lever 32.

The storage 13 includes a variety of information and a variety of programs stored therein. The storage 13 includes, for instance, one or more recording media such as an HDD (Hard Disk Drive) and/or an SSD (Solid State Drive). The storage 13 may be included in the controller 12 or the ferry operating controller 14. The storage 13 includes identification information, first location information, and second location information stored therein. The identification information includes information to identify the users of the plurality of watercraft 10 moored and stored in the marina 20. The information in the identification information are uniquely set in correspondence to the plurality of watercraft 10 moored and stored in the marina 20. For example, each piece of information in the identification information may be a character string of alphabetical and numerical symbols expressed by a predetermined number of digits.

The first location information indicates a first location where the ferry 30 is docked/undocked. The ferry 30 is moored in the first location depicted with a solid line in FIG. 2. The first location adjoins to the land on which the marina 20 is located.

The second location information includes information regarding second locations located on the water where the plurality of watercraft 10 are moored and stored. Each piece of information in the second location information includes information of a location of a buoy 46a (to be described) to moor the watercraft 10 of each user. The information in the second location information are associated with those in the identification information. In FIG. 2, the watercraft 10 of the first user is assigned reference character 10a.

The storage 13 includes a plurality of routes R from the first location to the second location stored therein. As shown in FIG. 2, a first route R1 and a second route R2, for instance, are included in the plurality of routes R from the first location to the second location where the watercraft 10a is moored and stored.

The ferry controlling system 1 includes a location detector 41, a speech detector 42, an obstruction detector 43, a battery 44, a charger 45, one or more moorings 46, and a detector 47.

The location detector 41 is in the ferry 30. For example, the location detector 41 is a GPS receiver. The location detector 41 obtains location information of the ferry 30 from a GPS satellite. The location detector 41 is connected to the ferry operating controller 14 in a communicable manner. The ferry operating controller 14 obtains a location of the ferry 30 based on a signal transmitted thereto from the location detector 41.

The speech detector 42 is in the ferry 30. For example, the speech detector 42 detects a user's voice obtained by a microphone and outputs a result of the detection to the ferry operating controller 14.

The obstruction detector 43 includes, for instance, a camera in the marina 20. The camera is operable to take pictures of a storage region in which the plurality of watercraft 10 are moored and stored. The obstruction detector 43 detects an obstruction along each of the plurality of routes R based on image data of pictures taken by the camera and outputs a result of detection to the controller 12. For example, when any watercraft other than the ferry 30 exists on any one of the plurality of routes R, the obstruction detector 43 detects the watercraft as the obstruction.

The battery 44 is in the ferry 30. The battery 44 supplies electricity to the ferry operating controller 14 and the marine propulsion device 33.

The charger 45 is able to supply electricity to the battery 44 when the ferry 30 is in the first location. The charger 45 is able to charge of the battery 44 in a wireless manner. For example, the charger 45 includes a non-contact charging pad. It should be noted that the charger 45 may be able to charge the battery 44 in a wired manner.

Each of the one or more moorings 46 moors and stores the watercraft 10 of each user. In the present example embodiment, the one or more moorings 46 include a plurality of moorings 46. The plurality of moorings 46 are spaced apart from each other at predetermined intervals. Each of the plurality of moorings 46 includes the buoy 46a to moor the watercraft 10 of each user and a connector 46b to connect the buoy 46a to the watercraft 10. It should be noted that in FIG. 2, only one of the plurality of moorings 46, by which the watercraft 10 of the first user is moored, is assigned reference character 46.

The buoy 46a is exposed out of the surface of the water. In the present example embodiment, the buoy 46a floats on the surface of the water. For example, the buoy 46a is connected to an anchor anchored to the bottom of the body of water and is fixed in location on the water by the anchor.

The connector 46b is fixed to the buoy 46a. For example, the connector 46b may be a metallic member having an annular shape. The watercraft 10 of each user is moored in a predetermined location by fixing a rope or chain extending from the watercraft 10 of each user to the connector 46b. It should be noted that the connector 46b may be a rope fixed to the buoy 46a. In this case, the watercraft 10 of each user may be moored in the predetermined location by being fixed to the rope fixed to the buoy 46a.

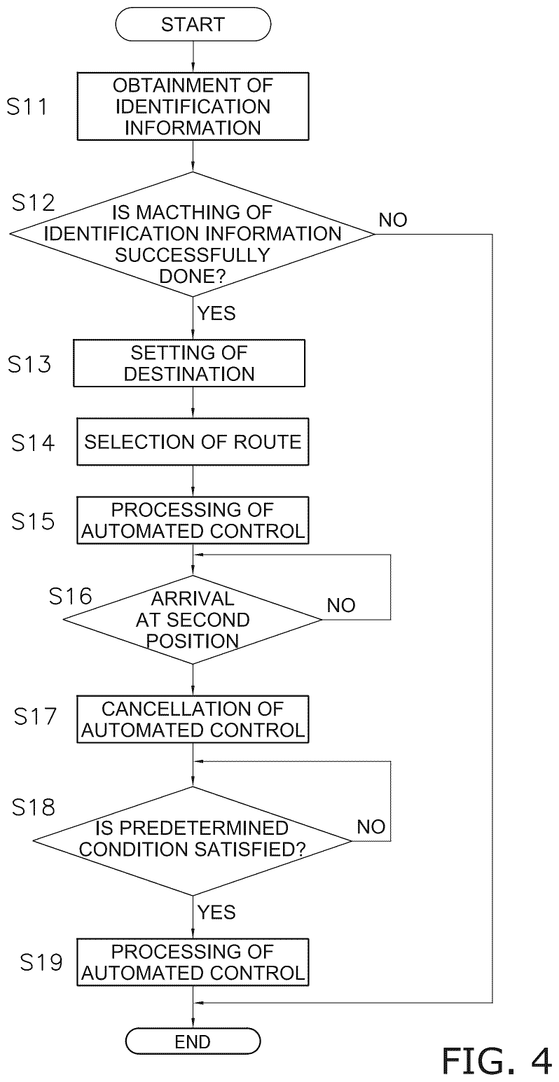

When the ferry 30 is in the first location, if receiving identification information in response to an input made through the communication terminal 15 of a user (step S11 in FIG. 4), the controller 12 determines whether the received identification information is matched with any of the information in the identification information stored in the storage 13 (step S12 in FIG. 4). When it is determined that the matching is successful for the received identification information, the controller 12 controls the ferry operating controller 14 to allow driving of the ferry 30 and sets the second location as a destination of the ferry 30 based on one of the pieces of information in the second location information that is associated with the received identification information (step S13 in FIG. 4).

For example, the controller 12 receives the identification information of the first user in response to an input made through the communication terminal 15a of the first user. When it is determined that matching is successful for the identification information of the first user, the controller 12 controls the ferry operating controller 14 to allow driving of the ferry 30 and sets, as the destination of the ferry 30, the second location (located in the vicinity of a location schematically depicted with dashed dotted line in FIG. 2) where the watercraft 10a of the first user is moored and stored.

When receiving the identification information, the controller 12 selects one of the plurality of routes R based on the result of detection by the obstruction detector 43 (step S14 in FIG. 4). For example, based on the result of detection by the obstruction detector 43, the controller 12 calculates a length of time estimated for arrival at the destination (herein referring to the second location) in each of the plurality of routes R and then selects one of the plurality of routes R such that the length of time estimated for arrival at the destination is shortest.

It should be noted that in a situation to allow driving of the ferry 30, the controller 12 preferably allows driving of the ferry 30 and sets the second location as the destination of the ferry 30 upon receiving the terminal location information from the communication terminal 15 of the user and then determining that the communication terminal 15 is in, or in the vicinity of, the first location. On the other hand, when the ferry 30 is not in the first location upon receiving identification information in response to an input made through the communication terminal 15 of the user, chances are high that the ferry 30 is being used by another user. Thus, the controller 12 gives a priority to execute an automated control that is currently being executed.

After setting the second location as the destination of the ferry 30, the controller 12 executes an automated control to automatically move the ferry 30 from the first location to the second location (step S15 in FIG. 4). The automated control is executed for the ferry 30 through the ferry operating controller 14. The controller 12 executes the automated control to automatically move the ferry 30 from the first location to the second location, for instance, in response to an operation performed on one or more buttons installed in the ferry 30. For example, the controller 12 outputs, to the communication terminal 15, a destination that has been set, a route for arriving at the destination, a length of time estimated for arrival at the destination, and so forth. The controller 12 may cause a display 38 installed in the ferry 30 to display the destination that has been set, the route for arriving at the destination, the length of time estimated for arrival at the destination, and so forth.

While executing the automated control for the ferry 30, the controller 12 may light up a lamp in the ferry 30 to provide external notification of an execution of the automated control.

When allowing driving of the ferry 30, the controller 12 may issue an alert to urge each person on board the ferry 30 to wear a life jacket. The controller 12 may cause the display 38 to display the alert to urge each person on board the ferry 30 to wear the life jacket. After receiving a response to the alert regarding wearing the life jacket from the user on board the ferry 30 through, for instance, the one or more buttons, the controller 12 may execute the automated control. The controller 12 may issue the alert regarding wearing the life jacket with a voice.

The controller 12 determines whether the ferry 30 has been moved from the first location to the second location based on a result of detection by the location detector 41 (step S16 in FIG. 4). When it is determined that the ferry 30 has been moved from the first location to the second location, the controller 12 switches the automated control executed by the ferry operating controller 14 into a manual control (step S17 in FIG. 4). Accordingly, the user on board the ferry 30 is able to bring the ferry 30 close to a boarding portion of the watercraft 10 of the user by manually operating the steering device 31 in the ferry 30.

After moving the ferry 30 from the first location to the second location, the controller 12 determines whether a predetermined condition is satisfied (step S18 in FIG. 4). When it is determined that the predetermined condition is satisfied, the controller 12 sets the first location as the destination of the ferry 30 based on the first location information and executes an automated control to automatically move the ferry 30 to the first location (step S19 in FIG. 4). At this time, for instance, based on the result of detection by the obstruction detector 43, the controller 12 may calculate a length of time estimated for arrival at the first location in each of the plurality of routes R and select one of the plurality of routes R such that the length of time estimated for arrival at the first location is shortest. After moving the ferry 30 from the first location to the

second location, the controller 12 determines whether the predetermined condition is satisfied based on a notification transmitted thereto from the communication terminal 15 of the user, the result of detection by the location detector 41, the result of detection by the speech detector 42, or a result of detection by the detector 47.

When receiving a predetermined notification from the communication terminal 15 of the user, the controller 12 determines that the predetermined condition is satisfied. For example, the controller 12 executes the automated control to automatically move the ferry 30 to the first location upon receiving a notification regarding completion of boarding of the first user on the watercraft 10a from the communication terminal 15 of the first user.

The controller 12 determines whether the ferry 30 is remote from the second location by a predetermined distance or greater based on the result of detection by the location detector 41. When it is determined that the ferry 30 is remote from the second location by the predetermined distance or greater, the controller 12 determines that the predetermined condition is satisfied. For example, after the first user is on board the watercraft 10a, if the ferry 30 is moved by the first user to move away from the second location, it is possible to execute the automated control to automatically move the ferry 30 to the first location. It should be noted that, under this condition, chances are that the automated control is unintentionally executed to automatically move the ferry 30 to the first location when the ferry 30 is moved away from the second location by the impact of wind and/or so forth. Because of this, the controller 12 may not be necessarily configured to determine whether the predetermined condition is satisfied based on the result of detection by the location detector 41.

The controller 12 determines whether boarding of the first user on the watercraft 10a has been completed based on the result of detection by the speech detector 42. For example, the controller 12 determines that the predetermined condition is satisfied when the speech detector 42 recognizes a speech such as “boarding completed”.

The detector 47 may be, for instance, a detecting sensor in the buoy 46a. The detector 47 detects movement of the watercraft 10a away from the second location. The detector 47 detects separation of the connector 46b from the watercraft 10a. For example, the detector 47 detects that the rope or chain, extending from the watercraft 10a of the first user to be fixed to the connector 46b, has been detached therefrom. For example, the detector 47 outputs the result of detection to the controller 12 through the ferry operating controller 14. The controller 12 determines that the predetermined condition is satisfied when the detector 47 detects separation of the connector 46b from the watercraft 10a.

The ferry controlling system 1 includes a camera 51, a falling-into-water detector 52, and a notifier 53. The camera 51 take pictures of the ferry 30 to generate image data. The camera 51 is in the ferry 30. The camera 51 take pictures of fore, aft, port, and starboard sides of the ferry 30. The falling-into-water detector 52 detects falling of a person on board the ferry 30 into the water (e.g., person overboard) based on the image data generated by the camera 51. The controller 12 determines whether a person on board has fallen into the water based on the result of detection by the falling-into-water detector 52.

When the falling-into-water detector 52 detects falling of a person on board into the water, the controller 12 externally issues an alert through the notifier 53. The notifier 53 includes a loudspeaker in the ferry 30. The notifier 53 externally outputs a sound through the loudspeaker. When the falling-into-water detector 52 detects falling of a person on board into the water, the controller 12 informs a company that manages and operates the marina 20, for instance, of the person on board falling into the water. When the falling-into-water detector 52 detects the falling of a person on board into the water, the controller 12 may cancel the automated control for the ferry 30.

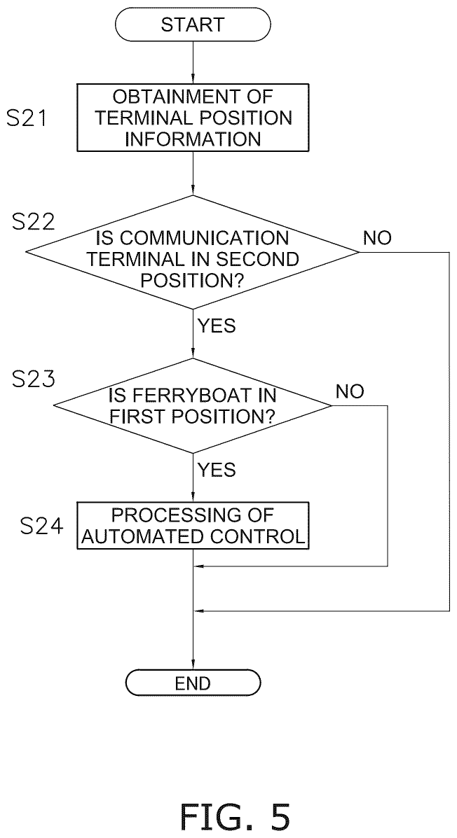

The user of the watercraft 10 is able to summon the ferry 30 to the second location with the user's own communication terminal 15. The user outputs the terminal location information of the communication terminal 15 to the controller 12. When receiving the terminal location information from the communication terminal 15 of the user (step S21 in FIG. 5), the controller 12 determines whether the communication terminal 15 is in the second location based on the terminal location information of the communication terminal 15 (step S22 in FIG. 5). When it is determined that the communication terminal 15 of the user is in the second location, the controller 12 determines whether the ferry 30 is in the first location (step S23 in FIG. 5). When it is determined that the ferry 30 is in the first location, the controller 12 sets the second location as the destination of the ferry 30 based on the second location information and executes the automated control to automatically move the ferry 30 from the first location to the second location (step S24 in FIG. 5). At this time, the controller 12 selects one of the plurality of routes R based on the result of detection by the obstruction detector 43.

When it is determined that the communication terminal 15 of the user is in the second location based on the terminal location information, the controller 12 outputs, to the communication terminal 15, information regarding a length of time required for the ferry 30 to arrive at the second location. For example, the user is able to check the arrival time of the ferry 30.

When it is determined that the communication terminal 15 of the user is in the second location based on the terminal location information, the controller 12 outputs present location information of the ferry 30 and destination information of the ferry 30 to the communication terminal 15. For example, the user is able to check the present location information of the ferry 30 and the destination information of the ferry 30.

It should be noted that, when it is determined that the ferry 30 is not in the first location, the controller 12 may execute the automated control to automatically move the ferry 30 from the first location to the second location after finishing executing the automated control that is currently being executed.

After the ferry 30 is moved from the first location to the second location, the controller 12 executes the automated control to automatically move the ferry 30 from the second location to the first location in response to an operation performed on, for example, the one or more buttons in the ferry 30.

In the ferry controlling system 1 described above, the controller 12 allows driving of the ferry 30 based on the identification information for identifying users of the plurality of watercraft 10. Thus, even when the marina 20 is closed, for example, on a holiday, a user is able to arrive at the user's watercraft 10 moored and stored on the water by using the ferry 30 in the marina 20. Additionally, the ferry 30 is prevented from being used by anyone other than the users of the marina 20 without permission. Furthermore, the controller 12 sets, as the destination of the ferry 30, the location in which the watercraft 10 of the user is moored and stored on the water. Thus, the user is able to easily arrive at the user's watercraft 10 moored and stored on the water.

Moreover, the controller 12 executes the automated control to automatically move the ferry 30 to the destination. Thus, a user is prevented from mistakenly arriving at the watercraft of any other user moored and stored in the marina 20. Furthermore, a user is prevented from boarding the watercraft of any other user without permission.

### Other Example Embodiments

In the example embodiments described above, the drive unit 35 of the marine propulsion device 33 causes the electric motor 35a to rotate the propeller. Alternatively, the drive unit 35 of the marine propulsion device 33 may be an internal combustion engine or a hybrid system of an internal combustion engine and an electric motor. A plurality of marine propulsion devices 33 may be provided. The server 3 may be in the ferry 30.

In the example embodiments described above, the automated control is configured to be executed for automatically moving the ferry 30. However, the automated control may be configured to move the ferry 30 from the first location to the second location or vice versa by a manual operation of a user.

In the example embodiments described above, the ferry controlling system 1 is used in the marina 20 where the plurality of watercraft 10 are moored and stored. However, the ferry controlling system 1 may not be limited to a ferry in the marina 20 and may be applied to a ferry that transports a user to the user's watercraft moored and stored in a specified location on the water.

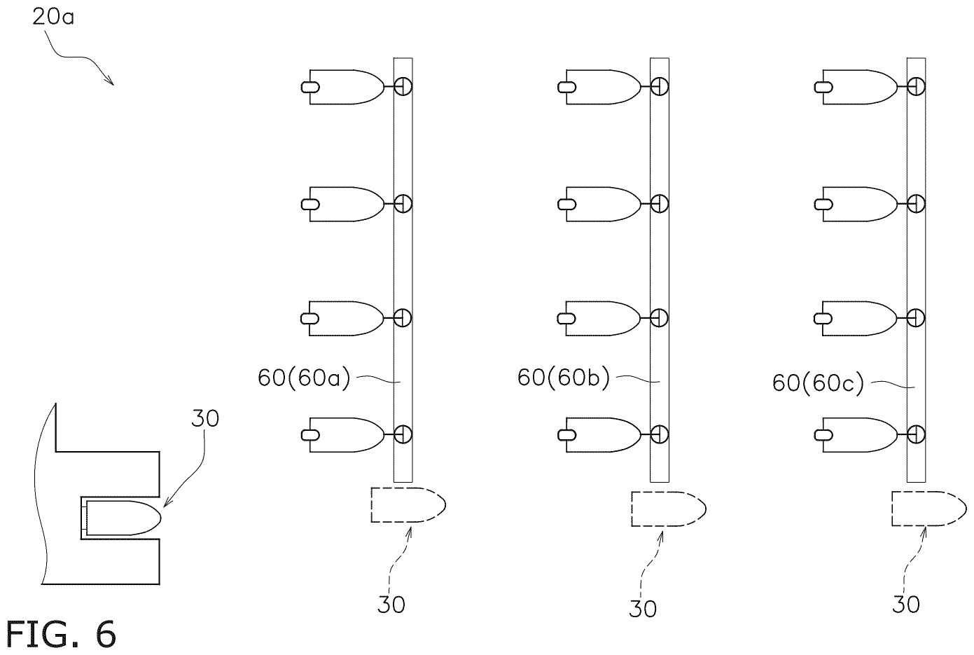

As shown in FIG. 6, a marina 20 may include one or more piers 60. The ferry controlling system may be used in a marina 20a provided with the one or more piers 60 floating on the water. The plurality of watercraft 10 may be moored and stored at the one or more piers 60. In this case, the one or more piers 60 are remote from the land where the marina 20 is located. That is, the users are not able to arrive at the watercraft 10 on foot via the one or more piers 60.

In the example embodiment shown in FIG. 6, the one or more piers 60 include a plurality of piers 60a to 60c. Two or more of the plurality of watercraft 10 are moored and stored at each of the plurality of piers 60a to 60c. The storage 13 has stored therein pier location information including information regarding docking locations of the ferry 30 for the plurality of piers 60a to 60c, respectively. In other words, the information in the second location information regarding the second location on the water (corresponding to the location where the watercraft 10 of a user is moored and stored) corresponds to that in the pier location information regarding a pier at which the watercraft 10 of the user is moored and stored. The information in the pier location information are associated with those in the identification information.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A system for controlling a ferry in a marina where a watercraft of a user is moored and stored, the system comprising:
a controller; and
a storage to store identification information identifying the user, first location information regarding a first location where the ferry is docked/undocked, and second location information regarding a second location on the water where the watercraft of the user is moored and stored; wherein
the controller is configured or programmed to allow driving of the ferry upon receiving the identification information, and set the second location as a destination of the ferry based on the second location information.

2. The system according to claim 1, wherein the controller is configured or programmed to execute an automated control to automatically move the ferry from the first location to the second location after setting the second location as the destination of the ferry.

3. The system according to claim 2, wherein the controller is configured or programmed to:
determine whether a predetermined condition is satisfied after moving the ferry from the first location to the second location; and
set the first location as the destination of the ferry based on the first location information and execute the automated control to automatically move the ferry to the first location when it is determined that the predetermined condition is satisfied.

4. The system according to claim 3, wherein the controller is configured or programmed to determine that the predetermined condition is satisfied upon receiving a predetermined notification from a communication terminal used by the user.

5. The system according to claim 3, further comprising:
a location detector to detect location information of the ferry;
wherein the controller is further configured or programmed to:
determine whether the ferry is remote from the second location by a predetermined distance or greater based on a result of detection by the location detector; and
determine that the predetermined condition is satisfied when it is determined that the ferry is remote from the second location by the predetermined distance or greater.

6. The system according to claim 3, further comprising:
a speech detector to recognize speech spoken by the user; wherein
the controller is configured or programmed to determine whether the predetermined condition is satisfied based on a result of detection by the speech detector.

7. The system according to claim 1, further comprising:
a detector to detect leaving of the watercraft from the second location; wherein
the controller is configured or programmed to set the first location as the destination of the ferry based on the first location information, and execute an automated control to automatically move the ferry to the first location when it is determined that the watercraft is away from the second location based on a result of detection by the detector while the ferry is in the second location.

8. The system according to claim 7, further comprising:
a mooring including a buoy to moor the watercraft and a connector to connect the buoy to the watercraft; wherein
the detector is operable to detect separation of the connector from the watercraft; and
the controller is configured or programmed to determine that the watercraft is away from the second location when the detector detects the separation of the connector from the watercraft.

9. The system according to claim 1, further comprising:
a camera to generate image data by taking a picture of the ferry;
a falling-into-water detector to detect falling of a person on board the ferry into the water based on the image data generated by the camera; and
a notifier to output an alert when the falling-into-water detector detects the falling of the person on board the ferry into the water.

10. The system according to claim 2, further comprising:
a location detector to detect location information of the ferry;
wherein the controller is configured or programmed to:
determine whether the ferry has been moved from the first location to the second location based on a result of detection by the location detector; and
switch the automated control into a manual control when it is determined that the ferry has been moved from the first location to the second location.

11. The system according to claim 1, wherein the second location information includes location information of a buoy usable to moor the watercraft.

12. The system according to claim 1, further comprising:
an obstruction detector; wherein
the storage is operable to store a plurality of routes from the first location to the second location;
the obstruction detector is operable to detect an obstruction along each of the plurality of routes; and
the controller is configured or programmed to select one of the plurality of routes based on a result of detection by the obstruction detector upon receiving the identification information.

13. The system according to claim 1, wherein the controller is configured or programmed to:
determine whether a communication terminal used by the user is in the second location based on terminal location information of the communication terminal upon receiving the terminal location information from the communication terminal; and
set the second location as the destination of the ferry based on the second location information and execute the automated control to automatically move the ferry from the first location to the second location when it is determined that the communication terminal is in the second location.

14. The system according to claim 13, wherein the controller is configured or programmed to output information to the communication terminal regarding a length of time required for the ferry to arrive at the second location when it is determined that the communication terminal is in the second location based on the terminal location information.

15. The system according to claim 13, wherein the controller is configured or programmed to output present location information of the ferry and destination information of the ferry to the communication terminal when it is determined that the communication terminal is in the second location based on the terminal location information.

16. The system according to claim 1, further comprising:
a battery on the ferry; and
a charger to supply electricity to the battery when the ferry is at the first location.

17. A system for controlling a ferry transporting a user to a watercraft that is moored and stored, the system comprising:
a controller; and
a storage to store identification information identifying the user, first location information regarding a first location where the ferry is docked/undocked, and second location information regarding a second location on the water where the watercraft of the user is moored and stored; wherein
the controller is configured or programmed to allow driving of the ferry upon receiving the identification information, and set the second location as a destination of the ferry based on the second location information.

18. A method of controlling a ferry in a marina where a watercraft of a user is moored and stored, the method comprising:
storing identification information identifying the user, first location information regarding a first location where the ferry is docked/undocked, and second location information regarding a second location on the water where the watercraft of the user is moored and stored; and
allowing driving of the ferry and setting the second location as a destination of the ferry based on the second location information upon receiving the identification information.

19. The method according to claim 18, further comprising:
executing an automated control to automatically move the ferry from the first location to the second location after setting the second location as the destination of the ferry.

20. A ferry in a marina where a watercraft of a user is moored and stored, the ferry comprising:
a controller; and
a storage to store identification information identifying the user, first location information regarding a first location where the ferry is docked/undocked, and second location information regarding a second location on the water where the watercraft of the user is moored and stored; wherein
the controller is configured or programmed to allow driving of the ferry upon receiving the identification information, and set the second location as a destination of the ferry based on the second location information.

21. The ferry according to claim 20, wherein the controller is configured or programmed to execute an automated control to automatically move the ferry from the first location to the second location after setting the second location as the destination of the ferry.
